(19) United States
(12) Patent Application Publication
(10) Pub. No.: US 2026/0042247 A1
(43) Pub. Date: Feb. 12, 2026

(54) MOLD CLAMPING DEVICE, INJECTION MOLDING MACHINE, AND MOLD CLAMPING METHOD

(71) Applicant: Shibaura Machine Co., Ltd., Tokyo (JP)

(72) Inventor: Yutaka MIYAKAWA, Numazu (JP)

(73) Assignee: Shibaura Machine Co., Ltd., Tokyo (JP)

(21) Appl. No.: 19/100,180

(22) PCT Filed: Jul. 12, 2023
(86) PCT No.: PCT/JP2023/025674

§ 371 Date: Jan. 31, 2025

(30) Foreign Application Priority Data
Aug. 4, 2022 (JP) 2022-124551

(51) Int. Cl. B29C 45/17; B29C 45/66; B29C 45/76

(52) U.S. Cl. CPC B29C 45/1751; B29C 45/661; B29C 45/7653; B29C 2945/76605; B29C 2945/76709

(57) ABSTRACT

A mold clamping device includes: a fixed die having a fixed mold; a movable die having a movable mold; a toggle link coupled to a link housing placed opposite to the fixed die and the movable die, and changing a distance therebetween by a mold clamping motor; a tie bar coupled to the fixed die and the link housing; a tie bar nut screwed onto the tie bar and placed on the link housing; and a control device that, when performing mold clamping, brings the movable mold close to the fixed mold at a slow speed immediately before the both come into contact with each other, stops the mold clamping motor for a predetermined period when the movable mold and the fixed mold come into contact with each other, increases the rotation speed of the mold clamping motor after the predetermined period elapses, to perform mold clamping.

### DESCRIPTION

### Technical Field The present invention relates to a mold clamping device, an injection molding machine, and a mold clamping method.

### Background Art

An injection molding machine that performs molding by injecting a resin melted in an injection cylinder into molds includes a mold clamping device that applies mold clamping force to the molds, and performs molding in a pair of molds in a state where mold clamping force is applied to the molds by the mold clamping device. The mold clamping device includes a fixed die, a movable die, and a link housing arranged side by side with spacing therebetween and a tie bar placed throughout between the fixed die and the link housing, and can change the distance between the fixed die and the movable die by using a link mechanism to change the distance between the movable die and the link housing. Thereby, the mold clamping device can apply mold clamping force to the molds placed on the fixed die and the movable die.

The fixed die and the tie bar are coupled to each other in a relatively unmovable manner; for the link housing and the tie bar, a tie bar nut placed on the link housing and the tie bar are screwed together; the distance between the fixed die and the link housing can be changed by rotating the tie bar nut with respect to the tie bar. Thereby, the distance between the fixed die and the movable die can be changed, and mold clamping force at the time of molding can be regulated.

Here, when the link mechanism is driven to generate mold clamping force by means of the mold clamping device, a force with a tendency to move in a direction away from the fixed die acts on the link housing due to reaction when generating mold clamping force. When a force in a direction away from the fixed die acts on the link housing, the tie bar nut placed on the link housing and screwed onto the tie bar may rotate with the movement of the link housing. In this case, the distance between the fixed die and the link housing changes, and when the link mechanism is driven to generate mold clamping force, a desired mold clamping force cannot be generated; consequently, a molding defect may occur.

Thus, among conventional injection molding machines, there is one that detects rotation of the tie bar nut when generating mold clamping force. For example, in an injection molding machine described in Patent Document 1, the rotation state of a tie bar nut is directly or indirectly detected by an encoder placed on a motor for rotating the tie bar nut or a rotation detector placed in the vicinity of a gear or the like for rotating the tie bar nut. Thereby, when rotation of the tie bar nut is detected, it is determined that the mold clamping force has decreased, and a warning is issued; thus, a molding defect is prevented.

### CITATION LIST

### Patent Literature

Patent Document 1: JP 2014-213507 A

### SUMMARY OF INVENTION

### Problem to be Solved by the Invention

However, in the case where a molding defect is prevented by issuing a warning when rotation of the tie bar nut is detected, after a warning is issued, it is necessary to stop molding performed by the injection molding machine and rotate the tie bar nut to readjust the distance between the fixed die and the link housing. In this case, since the molding process performed by the injection molding machine is interrupted, a reduction in efficiency when using the injection molding machine to mold a product to be molded is caused. Thus, to prevent interruption of the molding process, it is necessary to suppress a decrease in mold clamping force; however, in the conventional injection molding machine, when mold clamping force is repeatedly generated by the mold clamping device, it is difficult to suppress a decrease in mold clamping force.

The present invention has been made in view of the above, and an object of the present invention is to provide a mold clamping device, an injection molding machine, and a mold clamping method capable of suppressing a decrease in mold clamping force.

### Means for Solving Problem

In order to solve the above problem and achieve the object, a mold clamping device according to the present invention includes: a fixed die to which a fixed mold of a pair of molds composed of the fixed mold and a movable mold, is attached; a movable die to which the movable mold is attached and that is placed with such an orientation that the movable mold faces the fixed mold attached to the fixed die; a link housing placed opposite to where the fixed die is placed with respect to the movable die; a mold opening/closing mechanism that includes a toggle link and a mold clamping motor driving the toggle link, the toggle link being coupled to the link housing and the movable die and being capable of changing a distance between the link housing and the movable die, the mold opening/closing mechanism driving the toggle link by driving force generated by the mold clamping motor, to move the movable die with respect to the link housing, and thereby perform opening/closing and mold clamping of the movable mold attached to the movable die and the fixed mold; a tie bar having one end fixed to the fixed die and a second end coupled to the link housing; a mold thickness adjustment mechanism that includes a tie bar nut screwed onto a screw portion formed on the second end of the tie bar and placed on the link housing, the mold thickness adjustment mechanism rotating the tie bar nut to move, relative to the tie bar, the link housing together with the tie bar nut in an extending direction of the tie bar and thereby adjusting relative positions of the movable mold and the fixed mold, the movable mold being attached to the movable die coupled to the link housing via the toggle link; and a control device that controls the mold opening/closing mechanism and the mold thickness adjustment mechanism, in which when performing the mold clamping by, from a state where the molds are opened, closing the molds by the mold opening/closing mechanism, the control device sets rotation of the mold clamping motor to slow-speed rotation immediately before the movable mold and the fixed mold come into contact with each other, thereby brings the movable mold close to the fixed mold at a slow speed, stops the mold clamping motor for a predetermined period when the movable mold and the fixed mold come into contact with each other, and increases a rotation speed of the mold clamping motor after the predetermined period elapses, to perform the mold clamping.

Further, in order to solve the above problem and achieve the object, an injection molding machine according to the present invention includes: the above mold clamping device; and an injection device that melts a resin material in an injection cylinder having a screw placed inside and injects the molten resin material from a nozzle to the molds.

Further, in order to solve the above problem and achieve the object, a mold clamping method according to the present invention is a mold clamping method for a mold clamping device, the mold clamping device including: a fixed die to which a fixed mold of a pair of molds composed of the fixed mold and a movable mold, is attached; a movable die to which the movable mold is attached and that is placed with such an orientation that the movable mold faces the fixed mold attached to the fixed die; a link housing placed opposite to where the fixed die is placed with respect to the movable die; a mold opening/closing mechanism that includes a toggle link and a mold clamping motor driving the toggle link, the toggle link being coupled to the link housing and the movable die and being capable of changing a distance between the link housing and the movable die, the mold opening/closing mechanism driving the toggle link by driving force generated by the mold clamping motor, to move the movable die with respect to the link housing, and thereby perform opening/closing and mold clamping of the movable mold attached to the movable die and the fixed mold; a tie bar having one end fixed to the fixed die and a second end coupled to the link housing; and a mold thickness adjustment mechanism that includes a tie bar nut screwed onto a screw portion formed on the second end of the tie bar and placed on the link housing, the mold thickness adjustment mechanism rotating the tie bar nut to move, relative to the tie bar, the link housing together with the tie bar nut in an extending direction of the tie bar and thereby adjusting relative positions of the movable mold and the fixed mold, the movable mold being attached to the movable die coupled to the link housing via the toggle link, the mold clamping method including, when performing the mold clamping by, from a state where the molds are opened, closing the molds by the mold opening/closing mechanism, setting rotation of the mold clamping motor to slow-speed rotation immediately before the movable mold and the fixed mold come into contact with each other, thereby bringing the movable mold close to the fixed mold at a slow speed, stopping the mold clamping motor for a predetermined period when the movable mold and the fixed mold come into contact with each other, and increasing a rotation speed of the mold clamping motor after the predetermined period elapses, to perform the mold clamping.

### Effect of the Invention

A mold clamping device, an injection molding machine, and a mold clamping method according to the present invention exhibit an effect of being capable of suppressing a decrease in mold clamping force.

### BRIEF DESCRIPTION OF DRAWINGS

FIG. 1 is a side view of an injection molding machine according to an embodiment;

FIG. 2 is a side view of a mold clamping device illustrated in FIG. 1;

FIG. 3 is a view as seen in the direction of arrows A-A of FIG. 2;

FIG. 4 is a cross-sectional detailed diagram of a coupling portion between a tie bar and a link housing illustrated in FIG. 2;

FIG. 5 is an explanatory diagram of an injection molding cycle performed by the injection molding machine;

FIG. 6 is an explanatory diagram of an operation of the mold clamping device in a mold clamping step;

FIG. 7 is a detailed diagram of a tie bar and a tie bar nut;

FIG. 8 is a detailed diagram of a Ba portion and a Bb portion of FIG. 7;

FIG. 9 is a detailed diagram of a tie bar and a tie bar nut when a reaction force to mold clamping force acts on the tie bar nut in a conventional injection molding machine;

FIG. 10 is a detailed diagram of a Ca portion and a Cb portion of FIG. 9;

FIG. 11 is an explanatory diagram illustrating relationships between an operation of a crosshead and changes in mold clamping force, and movement of a mold thickness adjustment motor when performing mold clamping by means of a conventional injection molding machine; and

FIG. 12 is an explanatory diagram illustrating relationships between an operation of a crosshead and changes in mold clamping force, and movement of a mold thickness adjustment motor when performing mold clamping by means of the injection molding machine according to the embodiment.

### DESCRIPTION OF EMBODIMENTS

Hereinafter, embodiments of a mold clamping device, an injection molding machine, and a mold clamping method according to the present disclosure are described in detail based on the drawings. Note that this invention is not limited by the embodiments. The constituent elements in the following embodiments include those that can be substituted and easily conceived by those skilled in the art, or those that are substantially the same.

### Embodiments

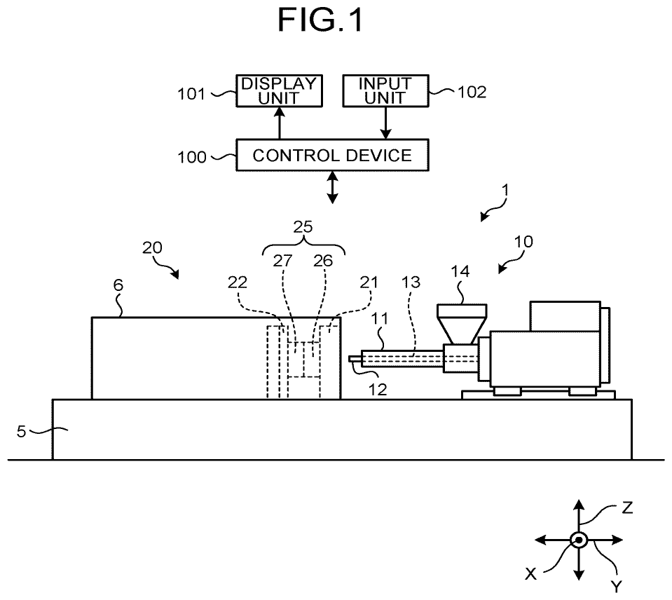

FIG. 1 is a side view of an injection molding machine 1 according to an embodiment. In the following description, the up-down direction in the normal use state of the injection molding machine 1 is described as an up-down direction Z in the injection molding machine 1, the upper side in the normal use state of the injection molding machine 1 is described as the upper side in the injection molding machine 1, and the lower side in the normal use state of the injection molding machine 1 is described as the lower side in the injection molding machine 1. Further, in the following description, the longitudinal direction Y of the injection molding machine 1 is described as a longitudinal direction Y also in each part including the injection molding machine 1, and a direction orthogonal to both the up-down direction Z and the longitudinal direction Y of the injection molding machine 1 is described as a width direction X in the injection molding machine 1.

### <Injection Molding Machine 1>

The injection molding machine 1 according to the present embodiment includes a fixed frame 5, an injection device 10 placed on the frame 5, and a mold clamping device 20 placed on the frame 5. The injection device 10 and the mold clamping device 20 are arranged side by side in the longitudinal direction Y on the frame 5, and the mold clamping device 20 is covered with a cover 6 on the frame 5.

### <Injection Device 10>

The injection device 10 includes an injection cylinder 11, a screw 13, and a hopper 14. The injection cylinder 11 is formed in a substantially cylindrical shape, and is placed such that the axial center direction is oriented along the longitudinal direction Y, and a nozzle 12 that ejects a resin material melted in the injection cylinder 11 is placed in an end portion in the longitudinal direction Y closer to where the mold clamping device 20 is located. Specifically, the injection cylinder 11 is provided with a heater (not illustrated) such as a band heater, and the temperature of the injection cylinder 11 can be increased by the heater. Thereby, the injection cylinder 11 can heat and melt the resin material in the inside of the injection cylinder 11 to make the resin material a molten resin that is a plasticizing material. The nozzle 12 is a portion that ejects the thus melted resin material from the inside of the injection cylinder 11 to the outside of the injection cylinder 11.

The screw 13 is placed in the inside of the injection cylinder 11, and has a spiral shape in which the axial center direction is a direction along the axial center direction of the injection cylinder 11; that is, the screw 13 has a spiral groove on its outer peripheral surface. Thus, the screw 13 having a spiral groove is rotatable about the axial center in the injection cylinder 11. Further, the screw 13 is placed in the injection cylinder 11 such that the center axis of the cylinder that is the shape of the injection cylinder 11 and the rotation axis of the screw 13 substantially coincide with each other, and the screw 13 is placed movably in the axial direction of the injection cylinder 11. The screw 13 placed rotatably in the injection cylinder 11 can knead the molten resin by rotating in the inside of the injection cylinder 11; thus, the injection cylinder 11 is a cylinder capable of kneading the molten resin in its inside.

A hopper 14 is placed in the vicinity of the injection cylinder 11 and opposite to where the nozzle 12 is located in the longitudinal direction Y with respect to the injection cylinder 11. The hopper 14 communicates with the inside of the injection cylinder 11, and is capable of supplying the injection cylinder 11 with a pellet (not illustrated) that is a resin material serving as a source resin.

The injection device 10 thus configured uses a metering motor (not illustrated) to rotate the screw 13, and while melting and kneading the resin material in the injection cylinder 11, accumulates the molten resin in a portion near the nozzle 12 of the injection cylinder 11; thereby, metering is performed. The molten resin accumulated in the injection cylinder 11 is ejected from the nozzle 12 by using an injection motor (not illustrated) and a ball screw and nut (not illustrated) to move the screw 13 toward where the nozzle 12 is located. Thereby, the injection device 10 injects the resin material melted in the injection cylinder 11 into molds 25 placed in the mold clamping device 20, and fills the cavity of the molds 25 with the molten resin.

### <Mold Clamping Device 20>

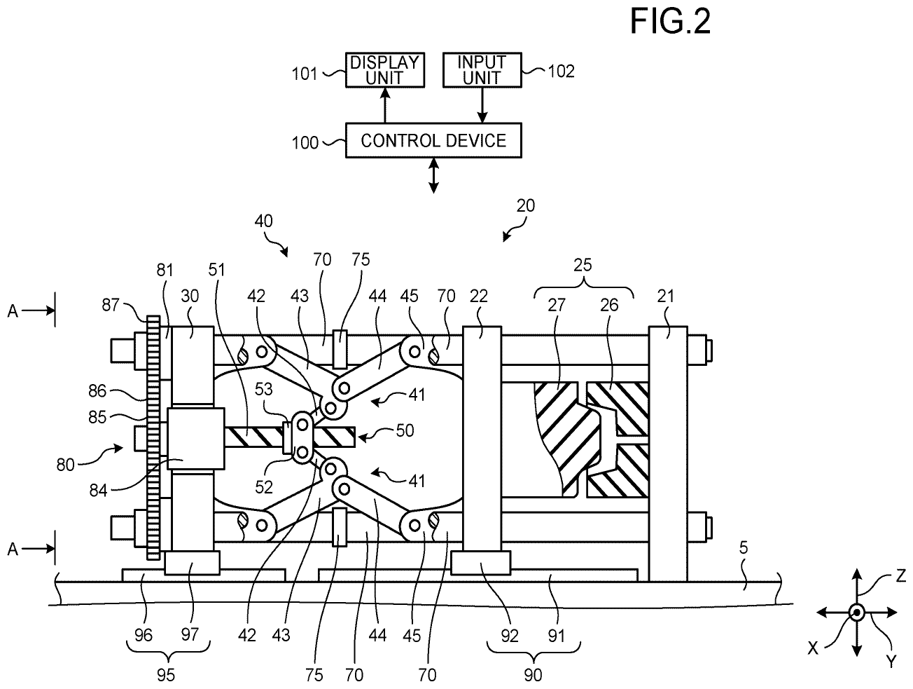

FIG. 2 is a side view of the mold clamping device 20 illustrated in FIG. 1. FIG. 2 serves as an explanatory diagram of the mold clamping device 20 in a state where the cover 6 is removed from the injection molding machine 1 illustrated in FIG. 1. In the description regarding the mold clamping device 20, the expression of each element of the mold clamping device 20 “moving forward” means that in the longitudinal direction Y, the element moves in the direction (the rightward direction of FIG. 2) toward where the injection device 10 is located with respect to the mold clamping device 20. Further, the expression of each element of the mold clamping device 20 “moving backward” means that in the longitudinal direction Y, the element moves in the opposite direction (the leftward direction of FIG. 2) to the direction toward where the injection device 10 is located with respect to the mold clamping device 20.

The mold clamping device 20 includes, for example, a fixed die 21 fixed to the frame 5, a movable die 22 placed to face the fixed die 21 and capable of coming close to or going away from the fixed die 21, and a link housing 30 placed movably on the frame 5.

Molds 25 used for molding of the resin material injected from the injection device 10 are attached to the fixed die 21 and the movable die 22. Of a pair of molds 25 composed of a fixed mold 26 and a movable mold 27, the fixed mold 26 is attached to the fixed die 21; and the movable mold 27 of the pair of molds 25 is attached to the movable die 22. The movable die 22 to which the movable mold 27 is attached is placed with such an orientation that the movable mold 27 faces the fixed mold 26 attached to the fixed die 21. Specifically, the movable die 22 is placed opposite to where the injection device 10 is placed with respect to the fixed die 21 in the longitudinal direction Y, and the movable die 22 and the fixed die 21 are arranged with such an orientation that the movable mold 27 attached to the movable die 22 and the fixed mold 26 attached to the fixed die 21 face each other in the longitudinal direction Y.

The link housing 30 is placed opposite to where the fixed die 21 is placed with respect to the movable die 22 in the longitudinal direction Y. That is, the fixed die 21, the movable die 22, and the link housing 30 are arranged in the order of the fixed die 21, the movable die 22, and the link housing 30 in the longitudinal direction Y from where the injection device 10 is located.

A plurality of tie bars 70 are arranged between the fixed die 21 and the link housing 30; in the present embodiment, four tie bars 70 are arranged. The tie bar 70 is formed in a rod shape extending in the longitudinal direction Y; one end side is fixed to the fixed die 21, and the other end side is coupled to the link housing 30. Thus, the fixed die 21 and the link housing 30 are coupled to each other via the tie bars 70. On the other hand, the tie bar 70 is not coupled to the movable die 22 placed between the fixed die 21 and the link housing 30, and the tie bar 70 penetrates the movable die 22 in the longitudinal direction Y. When performing mold clamping by tightening up the molds 25, the tie bar 70 can be elongated in the longitudinal direction Y by a mold opening/closing mechanism 40 described later, and can generate mold clamping force by a reaction force to the elongation.

A tie bar sensor 75 is attached to the tie bar 70. The tie bar sensor 75 is attached to each of the four tie bars 70. The tie bar sensor 75 is formed of, for example, a strain sensor, and can detect elongation in the extending direction of the tie bar 70, that is, elongation in the longitudinal direction Y of the tie bar 70. The tie bar sensor 75 that detects elongation of the tie bar 70 can, by detecting elongation of the tie bar 70, detect the magnitude of mold clamping force when performing the mold clamping of the molds 25 by means of the mold opening/closing mechanism 40. The tie bar sensor 75 may not be provided on all the four tie bars 70, and the tie bar sensor 75 may be provided on, for example, only one of the four tie bars 70.

The mold opening/closing mechanism 40 includes toggle links 41 and a driving device 50. The toggle link 41 is coupled to the link housing 30 and the movable die 22 and is capable of changing the distance between the link housing 30 and the movable die 22 in the longitudinal direction Y, and the driving device 50 is capable of driving the toggle link 41.

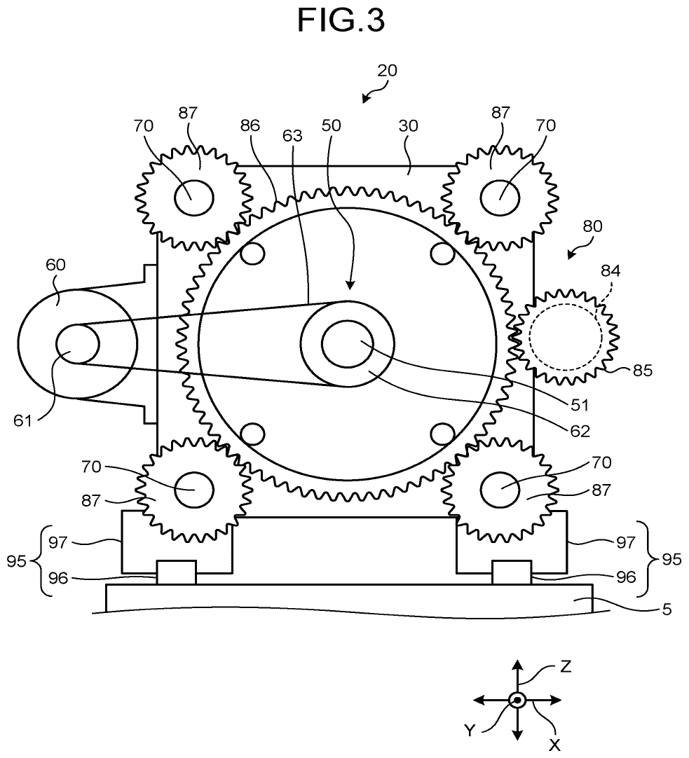

The driving device 50 includes a ball screw 51, a crosshead 52, a nut 53, and a mold clamping motor 60 (see FIG. 3). The ball screw 51 penetrates the link housing 30 in the longitudinal direction Y, and is placed to extend in the longitudinal direction Y mainly from the link housing 30 toward where the movable die 22 is located.

The nut 53 is attached to the crosshead 52, and the crosshead 52 is placed between the link housing 30 and the movable die 22 together with the nut 53. The nut 53 attached to the crosshead 52 is screwed onto the ball screw 51 between the link housing 30 and the movable die 22. Thus, by the ball screw 51 rotating, the crosshead 52 can move in the longitudinal direction Y integrally with the nut 53 screwed onto the ball screw 51. The crosshead 52 is provided with a guide (not illustrated) that guides the crosshead 52, and when moving in the longitudinal direction Y along the ball screw 51, the crosshead 52 moves while being guided by the guide.

FIG. 3 is a view as seen in the direction of arrows A-A of FIG. 2. The mold clamping motor 60 is attached to the link housing 30; in the present embodiment, the mold clamping motor 60 is attached to a side surface of the link housing 30 in the width direction X. The mold clamping motor 60 is, for example, a servomotor, and can drive the ball screw 51 via a first pulley 61, a timing belt 63, and a second pulley 62 sequentially. Specifically, the first pulley 61 is attached to an output shaft of the mold clamping motor 60. Further, the second pulley 62 is attached to an end portion of the ball screw 51 opposite to where the movable die 22 is located with respect to the link housing 30. The timing belt 63 is wound between the first pulley 61 and the second pulley 62, and transmits, to the ball screw 51 via the second pulley 62, the driving force generated by the mold clamping motor 60 and transmitted from the first pulley 61 to the timing belt 63.

The ball screw 51 is rotated by the driving force generated by the mold clamping motor 60 and transmitted to the ball screw 51 via the first pulley 61, the timing belt 63, and the second pulley 62. The nut 53 screwed onto the ball screw 51 moves in a straight line in the longitudinal direction Y along the ball screw 51, and the crosshead 52 formed integrally with the nut 53 moves in a straight line in the longitudinal direction Y along the ball screw 51 together with the nut 53.

The link housing 30 and the movable die 22 are coupled to each other by the toggle links 41 included in the mold opening/closing mechanism 40. The toggle link 41 includes a crosshead-side link 42, a link housing-side link 43, and a movable die-side link 44. Among them, for the link housing-side link 43, an end portion on the side located on the link housing 30 side in the longitudinal direction Y is coupled to the link housing 30 to be freely rotatable, and an opposite end portion is coupled to the movable die-side link 44 to be freely rotatable. For the movable die-side link 44, an end portion opposite to an end portion coupled to the link housing 30 in the longitudinal direction Y is coupled in a freely rotationally movable manner to the movable die 22 via a toggle link coupling unit 45.

Therefore, by the coupling portions moving rotationally, the link housing-side link 43 and the movable die-side link 44 can change the distance in the longitudinal direction Y between the end portion of the link housing-side link 43 on the side coupled to the link housing 30 and the end portion of the movable die-side link 44 on the side coupled to the movable die 22. Thereby, the link housing-side links 43 and the movable die-side links 44 coupled to the link housing 30 and the movable die 22 can change the distance in the longitudinal direction Y between the link housing 30 and the movable die 22.

For the crosshead-side link 42, one end is coupled to the crosshead 52 to be freely rotatable, and the other end is coupled to the link housing-side link 43 to be freely rotatable. Therefore, the crosshead-side link 42 can transmit the movement of the crosshead 52 moving in the longitudinal direction Y to the link housing-side link 43. Thereby, the crosshead-side link 42 can drive the link housing-side link 43 and the movable die-side link 44 having coupling portions coupled to be freely rotatable.

The toggle links 41 thus configured are arranged on both sides in the up-down direction Z with respect to the crosshead 52. That is, the toggle links 41 are arranged on both the upper side and the lower side in the up-down direction Z with respect to the crosshead 52, and the link housing 30 and the movable die 22 are coupled to each other via the upper and lower toggle links 41.

In the toggle link 41, the crosshead-side link 42 is coupled to the crosshead 52, and the crosshead 52 is placed to be movable in the longitudinal direction Y along the ball screw 51 by the driving force generated by the mold clamping motor 60. Therefore, in the toggle link 41, the movement of the crosshead 52 moving in the longitudinal direction Y by the driving force generated by the mold clamping motor 60 is transmitted to the crosshead-side link 42, and thereby the link housing-side link 43 and the movable die-side link 44 having the coupling portions coupled to be freely rotatable, operate. The driving device 50 can thus drive the toggle links 41 by the driving force generated by the mold clamping motor 60.

The mold opening/closing mechanism 40 can move the movable die 22 in the longitudinal direction Y with respect to the link housing 30 by driving the toggle links 41 by means of the driving device 50. Thereby, the mold opening/closing mechanism 40 can move, relative to the fixed mold 26 attached to the fixed die 21, the movable mold 27 attached to the movable die 22 in the longitudinal direction Y, and can perform the opening/closing and mold clamping of the movable mold 27 and the fixed mold 26.

When performing the mold closing or mold clamping of the fixed mold 26 and the movable mold 27 by means of the mold opening/closing mechanism 40, the crosshead 52 is moved forward by the mold clamping motor 60, and the mold opening/closing mechanism 40 is extended. That is, by driving the mold clamping motor 60, the ball screw 51 is rotationally moved in a predetermined direction via the timing belt 63, and the nut 53 screwed onto the ball screw 51 and the crosshead 52 provided integrally with the nut 53 are moved forward in a direction in the longitudinal direction Y toward where the fixed die 21 is located. At this time, the link housing-side link 43 and the movable die-side link 44 on the upper side open in the upward direction and the link housing-side link 43 and the movable die-side link 44 on the lower side open in the downward direction, and the movement of the crosshead 52 is transmitted to the movable die 22 via the toggle links 41. Thereby, the mold closing or mold clamping of the fixed mold 26 and the movable mold 27 is performed.

When performing mold opening on the fixed mold 26 and the movable mold 27, conversely, the crosshead 52 is moved backward by the mold clamping motor 60, and the link housing-side links 43 and the movable die-side links 44 are bent. That is, by driving the mold clamping motor 60, the ball screw 51 is rotationally moved in the opposite direction to that at the time of mold closing via the timing belt 63, and the nut 53 and the crosshead 52 are moved backward in a direction in the longitudinal direction Y toward where the link housing 30 is located. Thus, by moving the nut 53 backward in the direction toward where the link housing 30 is located, the link housing-side link 43 and the movable die-side link 44 on the upper side close in the downward direction and the link housing-side link 43 and the movable die-side link 44 on the lower side close in the upward direction, and the movement of the crosshead 52 is transmitted to the movable die 22 via the toggle links 41. Thereby, the mold opening of the fixed mold 26 and the movable mold 27 is performed.

Thus, in the present embodiment, in a state where mold closing or mold clamping is completed, the link housing-side link 43 and the movable die-side link 44 form a substantially straight line, and at the time of mold opening, the link housing-side link 43 and the movable die-side link 44 bend toward where the axis of the ball screw 51 is located. That is, there is a structure in which, at the time of mold opening, the link housing-side link 43 and the movable die-side link 44 bend to wind on the inside in the up-down direction Z.

A first linear guide 90 that is a guide mechanism that guides the movable die 22 is provided on the frame 5. The first linear guide 90 can guide the movable die 22 for movement in the longitudinal direction Y. The first linear guide 90 includes first guide rails 91 placed on the frame 5 and extending in the longitudinal direction Y, and a first block 92 attached to the movable die 22 and movable along the first guide rail 91 while sliding with respect to the first guide rail 91. The first guide rails 91 are arranged on the frame 5 in two positions near both ends of the movable die 22 in the width direction X, and are formed to extend over both sides of the movable die 22 in the longitudinal direction Y. The first blocks 92 are arranged in two positions near both ends of the movable die 22 in the width direction X, and the first blocks 92 in two places are attached to the movable die 22 such that the spacing therebetween in the width direction X is substantially the same as the spacing between the first guide rails 91.

Further, a second linear guide 95 that is a guide mechanism that guides the link housing 30 is provided on the frame 5. The second linear guide 95 can guide the link housing 30 for movement in the longitudinal direction Y. The second linear guide 95 includes second guide rails 96 placed on the frame 5 and extending in the longitudinal direction Y, and a second block 97 attached to the link housing 30 and movable along the second guide rail 96 while sliding with respect to the second guide rail 96. The second guide rails 96 are arranged on the frame 5 in two positions near both ends of the link housing 30 in the width direction X, and are formed to extend over both sides of the link housing 30 in the longitudinal direction Y. The second blocks 97 are arranged in two positions near both ends of the link housing 30 in the width direction X, and the second blocks 97 in two places are attached to the link housing 30 such that the spacing therebetween in the width direction X is substantially the same as the spacing between the second guide rails 96.

The first guide rail 91 of the first linear guide 90 and the second guide rail 96 of the second linear guide 95 may be continuously formed to constitute the same guide rail.

The four tie bars 70 coupling the fixed die 21 and the link housing 30 are coupled to two places near both ends in the width direction X and two places near both ends in the up-down direction Z of each of the fixed die 21 and the link housing 30 (see FIG. 3). That is, the four tie bars 70 are coupled to four corners near both ends in the width direction X and near both ends in the up-down direction Z of each of the fixed die 21 and the link housing 30.

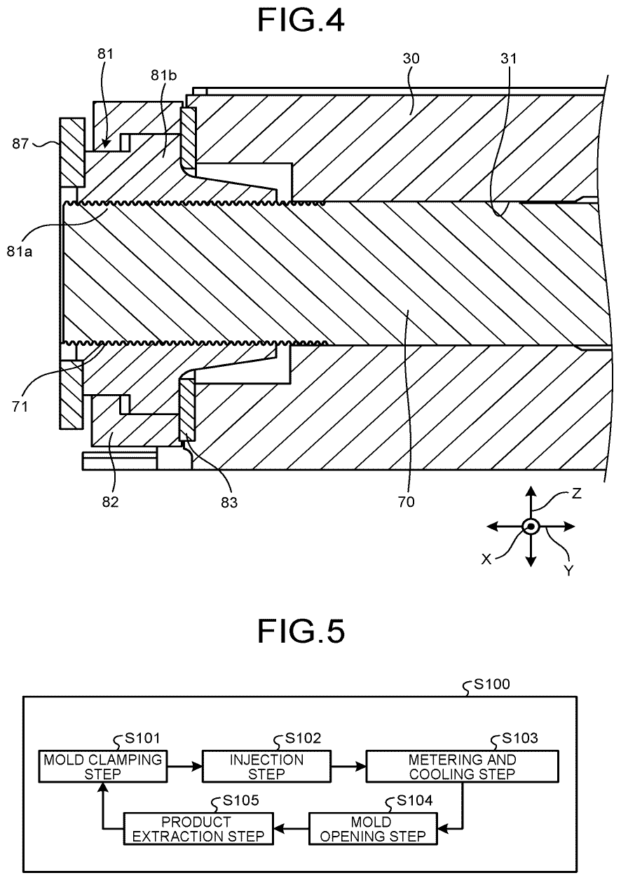

For the tie bars 70 thus arranged, a screw portion 71 (see FIG. 4) is formed on the outer peripheral surface of the tie bar 70 near the end on the side coupled to the link housing 30. A tie bar nut 81 screwed onto the screw portion 71 of the tie bar 70 is placed on the link housing 30, and thus the tie bar 70 and the link housing 30 are coupled to each other by the tie bar nut 81.

FIG. 4 is a cross-sectional detailed diagram of a coupling portion between the tie bar 70 and the link housing 30 illustrated in FIG. 2. FIG. 4 is a detailed diagram of a coupling portion between one tie bar 70 and the link housing 30, and all the four tie bars 70 are similarly formed. The tie bar nut 81 is placed opposite to where the fixed die 21 and the movable die 22 are placed in the thickness direction of the link housing 30, that is, the longitudinal direction Y. A flange portion 81b protruding on the outside in the diametrical direction of the tie bar nut 81 is formed on the outer peripheral surface of the tie bar nut 81.

A nut support member 82 that supports the tie bar nut 81 is placed on the side of a surface on the side in the thickness direction of the link housing 30 where the tie bar nut 81 is placed. The nut support member 82 is attached to the link housing 30 such that the flange portion 81b of the tie bar nut 81 is interposed between the nut support member 82 and the link housing 30. The nut support member 82 attached to the link housing 30 supports the tie bar nut 81 to be freely rotatable while restricting movement of the flange portion 81b of the tie bar nut 81 away from the link housing 30 in the longitudinal direction Y. Thereby, the tie bar nut 81 is placed on the link housing 30 to be freely rotatable.

A thrust washer 83 that receives force in the longitudinal direction Y between the tie bar nut 81 and the link housing 30 is placed between the flange portion 81b of the tie bar nut 81 and the link housing 30. Thereby, the tie bar nut 81 can rotate even in a state where a load in the longitudinal direction Y is applied to the tie bar nut 81 toward the link housing 30.

A through hole 31 into which the tie bar 70 is inserted is formed in the link housing 30. The through hole 31 is a hole having the inner diameter almost equal to the outer diameter of the tie bar 70, and is formed to penetrate the link housing 30 in the thickness direction of the link housing 30, that is, the longitudinal direction Y. The tie bar 70 is inserted into the through hole 31 thus formed in the link housing 30, and is coupled to the link housing 30.

The tie bar nut 81 is placed in, of the through hole 31 formed in the link housing 30, a portion open to a surface opposite to where the fixed die 21 and the movable die 22 are placed in the longitudinal direction Y. A screw portion 81a formed as a female screw is formed on the inner peripheral surface of the tie bar nut 81, which is placed on the link housing 30 by the nut support member 82. On the other hand, the screw portion 71 of the tie bar 70 forms a male screw; thereby, in the tie bar nut 81, the screw portion 81a of the tie bar nut 81 is screwed onto the screw portion 71 of the tie bar 70.

Since the screw portion 81a of the tie bar nut 81 is thus screwed onto the screw portion 71 of the tie bar 70, by rotating the tie bar nut 81, the tie bar nut 81 can move relative to the tie bar 70 in the longitudinal direction Y, which is the extending direction of the tie bar 70.

The tie bar nuts 81 are placed on the link housing 30, and the link housing 30 is placed on the frame 5 via the second linear guide 95 that guides the link housing 30 for movement in the longitudinal direction Y. Therefore, when the tie bar nuts 81 are rotated, the tie bar nuts 81 move relative to the tie bars 70 in the longitudinal direction Y, and thereby also the link housing 30 on which the tie bar nuts 81 are placed can move in the longitudinal direction Y while being guided by the second linear guide 95.

Thus, the tie bar nuts 81 that can move the link housing 30 in the longitudinal direction Y by rotating with respect to the tie bars 70 constitute a mold thickness adjustment mechanism 80. The mold thickness adjustment mechanism 80 includes, in addition to the tie bar nuts 81, a mold thickness adjustment motor 84, a driving gear 85, an annular gear 86, and tie bar nut gears 87 (see FIGS. 2 and 3).

Among them, the tie bar nut gears 87 are attached individually to the four tie bar nuts 81, which are screwed individually to the four tie bars 70. The annular gear 86 is placed to mesh with the four tie bar nut gears 87. The driving gear 85 is attached to an output shaft of the mold thickness adjustment motor 84, and is placed to mesh with the annular gear 86 to drive the annular gear 86. The mold thickness adjustment motor 84 is, for example, a servomotor, and is provided as a power source of the mold thickness adjustment mechanism 80. The mold thickness adjustment motor 84 is attached to the link housing 30; in the present embodiment, the mold thickness adjustment motor 84 is attached to a side surface of the link housing 30 in the width direction X.

In the mold thickness adjustment mechanism 80 thus configured, the driving gear 85 rotates by the mold thickness adjustment motor 84 being driven. The rotating driving gear 85 rotates the four tie bar nut gears 87 in the same direction via the annular gear 86, and rotates the four tie bar nuts 81 in the same direction. When the tie bar nuts 81 rotate, the tie bar nuts 81 move relative to the tie bars 70 in the longitudinal direction Y together with the link housing 30; therefore, when the tie bar nuts 81 rotate, the mold thickness adjustment mechanism 80 including the tie bar nuts 81 moves relative to the tie bars 70 in the longitudinal direction Y integrally with the link housing 30.

Here, the mold opening/closing mechanism 40 is placed on the link housing 30, and the link housing 30 is coupled to the movable die 22 via the toggle links 41 included in the mold opening/closing mechanism 40. Further, the movable die 22 is placed on the frame 5 via the first linear guide 90 that guides the movable die 22 for movement in the longitudinal direction Y. Therefore, when the link housing 30 moves in the longitudinal direction Y by means of the mold thickness adjustment mechanism 80, also the movable die 22 coupled to the link housing 30 via the toggle links 41 moves in the longitudinal direction Y integrally with the link housing 30 while being guided by the first linear guide 90.

Since the movable mold 27 is attached to the movable die 22, when the movable die 22 moves in the longitudinal direction Y, the movable mold 27 attached to the movable die 22 experiences a change in distance to the fixed mold 26 attached to the fixed die 21. Thus, the mold thickness adjustment mechanism 80 can adjust the relative positions of the movable mold 27 and the fixed mold 26.

As above, by rotating the tie bar nuts 81 to move, relative to the tie bars 70, the link housing 30 together with the tie bar nuts 81 in the extending direction of the tie bar 70, the mold thickness adjustment mechanism 80 can adjust the relative positions of the movable mold 27 attached to the movable die 22 coupled to the link housing 30 via the toggle links 41 and the fixed mold 26. Thus, for example, when the molds 25 are replaced, the distance in the longitudinal direction Y between the fixed mold 26 and the movable mold 27 can be adjusted as appropriate by using the mold thickness adjustment mechanism 80 to move the link housing 30 and the movable mold 27 in the longitudinal direction Y according to the thickness of the molds 25 in the longitudinal direction Y. In the present embodiment, rotation with which the tie bar nut 81 moves forward along the tie bar 70 when the tie bar nut 81 is rotated is referred to as “positive rotation”. In contrast, in the present embodiment, rotation with which the tie bar nut 81 moves backward along the tie bar 70 when the tie bar nut 81 is rotated is referred to as “reverse rotation”.

The injection molding machine 1 further includes a control device 100 that performs various pieces of control of the injection molding machine 1. The control device 100 includes a CPU (central processing unit) that performs arithmetic processing, a RAM (random access memory) and a ROM (read only memory) that function as memories that store various pieces of information, etc. All or some of the functions of the control device 100 are implemented by loading an application program stored in the ROM into the RAM and executing the program with the CPU to perform reading and writing of data in the RAM or the ROM.

A display unit 101 that displays various pieces of information of the injection molding machine 1 and an input unit 102 used when the operator performs an input operation on the injection molding machine 1 are connected to the control device 100. The display unit 101 connected to the control device 100 displays information transmitted from the control device 100, and the input unit 102 transmits information based on an input operation to the control device 100.

The injection molding machine 1 is provided with various sensors that detect various states during operation of the injection molding machine 1, and these sensors are connected to the control device 100. The control device 100 controls actuators of the injection molding machine 1 on the basis of detection results from these sensors, and thereby controls the operation of the injection molding machine 1.

For example, the tie bar sensor 75 placed on the tie bar 70 is connected to the control device 100, and can transmit a detection result to the control device 100. Further, each of the mold clamping motor 60 included in the mold opening/closing mechanism 40 and the mold thickness adjustment motor 84 included in the mold thickness adjustment mechanism 80 is provided with an encoder (not illustrated), and also these encoders are coupled to the control device 100 and can transmit detection results to the control device 100.

Also the heater (not illustrated) placed on the injection cylinder 11 of the injection device 10, the mold clamping motor 60 included in the mold opening/closing mechanism 40, and the mold thickness adjustment motor 84 included in the mold thickness adjustment mechanism 80 are connected to the control device 100, and operate with control signals from the control device 100. Thereby, the control device 100 can control the injection device 10, and the mold opening/closing mechanism 40 and the mold thickness adjustment mechanism 80 included in the mold clamping device 20.

### <Working of the Injection Molding Machine 1>

The injection molding machine 1 according to the present embodiment includes a configuration like the above; the working will now be described. The control of the driving device 50 and the mold thickness adjustment mechanism 80 of the mold clamping device 20 described below is performed by the control device 100.

FIG. 5 is an explanatory diagram of an injection molding cycle performed by the injection molding machine 1. First, a flow of the entire injection molding process is briefly described. When performing injection molding, as illustrated in FIG. 5, the injection molding machine 1 according to the present embodiment performs an injection molding cycle S100. The injection molding machine 1 uses the control device 100 to control the actuators of the injection molding machine 1 while using the control device 100 to acquire the operating states of the units of the injection molding machine 1 from detection results of the sensors, and thereby performs injection molding. Specifically, the injection molding cycle S100 when performing injection molding with the injection molding machine 1 includes a mold clamping step S101, an injection step S102, a metering and cooling step S103, a mold opening step S104, and a product extraction step S105, and these steps are sequentially repeated to produce a large number of molded products.

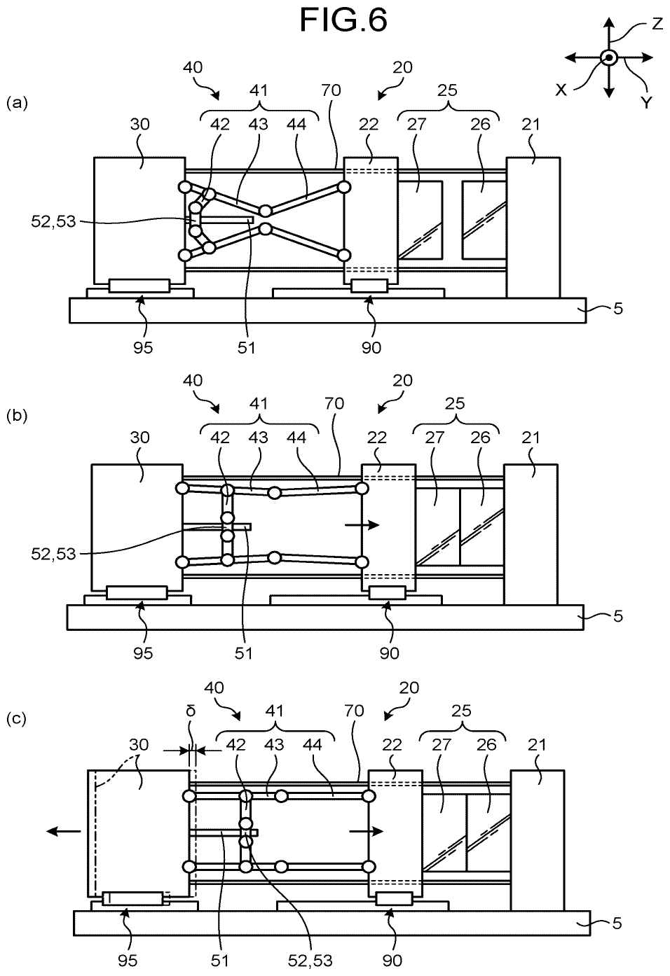

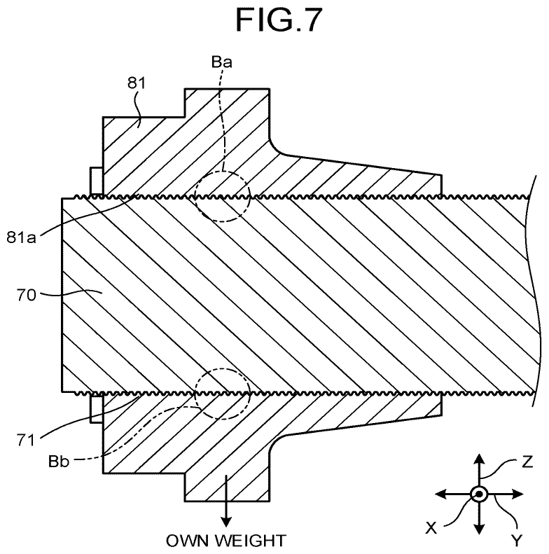

Next, the working of the mold clamping device 20 in the mold clamping step S101 is described. FIG. 6 is an explanatory diagram of an operation of the mold clamping device 20 in the mold clamping step. At the time of the start of the mold clamping step S101, as illustrated in (a) of FIG. 6, the mold clamping device 20 sets the condition to a mold-opened state in which the movable mold 27 is separated from the fixed mold 26.

In the mold clamping step S101, the mold clamping device 20 performs the mold closing and mold clamping of the molds 25 from the mold-opened state. When performing the mold closing of the molds 25, the control device 100 drives the mold clamping motor 60 included in the mold opening/closing mechanism 40 of the mold clamping device 20, and thereby moves the crosshead 52 forward. Thereby, the link housing-side link 43 and the movable die-side link 44 included in the toggle link 41 extend. That is, by the mold clamping motor 60 being driven, the ball screw 51 moves rotationally in a predetermined direction via the timing belt 63, and the nut 53 screwed onto the ball screw 51 and the crosshead 52 move forward in a direction in the longitudinal direction Y toward where the fixed die 21 is located.

When the crosshead 52 moves in the longitudinal direction Y, the movement of the crosshead 52 is transmitted to the link housing-side link 43 via the crosshead-side link 42 included in the toggle link 41. Thereby, the toggle link 41 on the upper side operates in such a direction that the link housing-side link 43 and the movable die-side link 44 open in the upward direction in the up-down direction Z, and the toggle link 41 on the lower side operates in such a direction that the link housing-side link 43 and the movable die-side link 44 open in the downward direction in the up-down direction Z.

Since an end portion of the movable die-side link 44 opposite to an end portion coupled to the link housing-side link 43 is coupled to the movable die 22, when the link housing-side link 43 and the movable die-side link 44 operate in the opening direction, the movable die 22 moves forward with the movement of the movable die-side link 44. When performing mold closing, in this way, the movement in the longitudinal direction Y of the crosshead 52 is transmitted to the movable die 22 via the toggle links 41, and the movable die 22 moves forward on the side in the longitudinal direction Y where the fixed die 21 is located.

The movable mold 27 is attached to a surface of the movable die 22 closer to where the fixed die 21 is located. On the other hand, the fixed mold 26 is attached to a surface of the fixed die 21 closer to where the movable die 22 is located. Therefore, when the movable die 22 moves forward on the side in the longitudinal direction Y where the fixed die 21 is located, the movable mold 27 attached to the movable die 22 comes into contact with the fixed mold 26 attached to the fixed die 21. Thus, by the movable mold 27 attached to the movable die 22 coming into contact with the fixed mold 26 attached to the fixed die 21, the mold closing of the fixed mold 26 and the movable mold 27 is performed ((b) of FIG. 6).

When the fixed mold 26 and the movable mold 27 come into contact with each other and make mold closing, the tie bar 70 elongates extremely slightly in the longitudinal direction Y. The elongation of the tie bar 70 is detected by the tie bar sensor 75 attached to the tie bar 70, and the detection result is transmitted to the control device 100. Thereby, the control device 100 detects that the mold closing of the fixed mold 26 and the movable mold 27 is performed.

When the fixed mold 26 and the movable mold 27 have made mold closing, the control device 100 further drives the mold clamping motor 60 included in the mold opening/closing mechanism 40 of the mold clamping device 20, and thereby further moves the crosshead 52 forward. Thereby, the movable mold 27 is pressed against the fixed mold 26, and the mold clamping of the fixed mold 26 and the movable mold 27 is performed ((c) of FIG. 6).

At this time, the tie bar 70 further elongates slightly in the longitudinal direction Y. That is, when the mold clamping motor 60 is driven to extend the link housing-side links 43 and the movable die-side links 44 of the toggle links 41 and thereby the movable mold 27 is pressed against the fixed mold 26, the distance between the link housing 30 and the movable die 22 is widened by the extension of the toggle links 41, and therefore the link housing 30 moves slightly in the longitudinal direction Y opposite to where the fixed die 21 is located.

Since an end portion of the tie bar 70 opposite to an end portion fixed to the fixed die 21 is coupled to the link housing 30 by the tie bar nut 81, when the link housing 30 moves in the longitudinal direction Y opposite to where the fixed die 21 is located, the tie bar 70 elongates slightly in the longitudinal direction Y with the movement of the link housing 30. The amount of elongation δ of the tie bar 70 when the tie bar 70 thus elongates is, for example, about 1 to 5 mm. That is, when the tie bar 70 elongates, the link housing 30, while being guided by the second linear guide 95, moves in the longitudinal direction Y opposite to where the fixed die 21 is located, and the tie bar 70 elongates by an amount equal to the amount of movement of the link housing 30.

Since both ends of the tie bar 70 are coupled to the fixed die 21 and the link housing 30, when the tie bar 70 elongates, a force with a tendency to contract acts on the fixed die 21 and the link housing 30. That is, a reaction force with a tendency to contract is generated in the elongated tie bar 70, and the force with a tendency for the tie bar 70 to contract acts on the fixed die 21 and the link housing 30 as a force in a direction to reduce the distance between them in the longitudinal direction Y.

Since the movable die 22 to which the movable mold 27 is attached is coupled to the link housing 30 via the toggle links 41, when a force with a tendency for the tie bar 70 to contract acts on the fixed die 21 and the link housing 30, this force acts as a force of pressing the movable mold 27 attached to the movable die 22 against the fixed mold 26 attached to the fixed die 21. Thereby, mold clamping force that is a force with which the fixed mold 26 and the movable mold 27 are pressed against each other in the longitudinal direction Y is generated on both molds.

On the other hand, in the mold opening step S104, the mold clamping device 20 moves the crosshead 52 backward in the longitudinal direction Y by means of the mold opening/closing mechanism 40 and bends the link housing-side links 43 and the movable die-side links 44, and thereby causes the fixed mold 26 and the movable mold 27 to make mold opening. That is, the control device 100 drives the mold clamping motor 60 included in the mold opening/closing mechanism 40 of the mold clamping device 20 and thereby rotationally moves the ball screw 51 in the opposite direction to that at the time of mold closing via the timing belt 63, and moves the nut 53 screwed onto the ball screw 51 and the crosshead 52 backward in a direction in the longitudinal direction Y toward where the link housing 30 is located.

When the crosshead 52 is moved backward, the toggle link 41 on the upper side operates in such a direction that the link housing-side link 43 and the movable die-side link 44 close in the downward direction in the up-down direction Z, and the toggle link 41 on the lower side operates in such a direction that the link housing-side link 43 and the movable die-side link 44 close in the upward direction in the up-down direction Z. Thereby, the movable die 22 coupled to the link housing 30 via the toggle links 41 moves backward on the side in the longitudinal direction Y where the link housing 30 is located, and the mold opening of the fixed mold 26 and the movable mold 27 is performed.

Thus, in the injection molding machine 1 according to the present embodiment, in a state where mold closing and mold clamping are completed, the link housing-side link 43 and the movable die-side link 44 included in the toggle link 41 form a substantially straight line. Further, there is a structure in which, at the time of mold opening, the link housing-side link 43 and the movable die-side link 44 bend toward where the axis of the ball screw 51 is located, that is, bend to wind on the inside in the up-down direction Z.

Next, a method for adjusting the mold thickness performed by the mold thickness adjustment mechanism 80 is described. The adjustment of the mold thickness by the mold thickness adjustment mechanism 80 is performed when, for example, the molds 25 attached to the fixed die 21 and the movable die 22 are replaced, or on like occasions. That is, for the mold clamping force produced by the mold opening/closing mechanism 40, in a state where the link housing-side link 43 and the movable die-side link 44 form a substantially straight line, the tie bar 70 is elongated, and the maximum mold clamping force is generated. On the other hand, for the thickness of the molds 25 attached to the fixed die 21 and the movable die 22, the thickness in the longitudinal direction Y may be different between sets of molds 25.

When the thickness of the molds 25 is different, in the mold clamping step, the fixed mold 26 and the movable mold 27 may come into contact with each other before the link housing-side link 43 and the movable die-side link 44 form a substantially straight line, or the fixed mold 26 and the movable mold 27 may not come into contact with each other even in a state where the link housing-side link 43 and the movable die-side link 44 form a substantially straight line. In this case, an appropriate mold clamping force cannot be generated on the molds 25 in the mold clamping step; thus, when the molds 25 are replaced, the timing at which the fixed mold 26 and the movable mold 27 come into contact with each other, with respect to the state of the toggle link 41, in the mold clamping step is adjusted by the mold thickness adjustment mechanism 80.

For example, in the case where the thickness in the longitudinal direction Y of the molds 25 after replacement is smaller than the thickness of the molds 25 before replacement, the control device 100 drives the mold thickness adjustment motor 84 included in the mold thickness adjustment mechanism 80 to positively rotate the tie bar nut 81, and thereby moves, with respect to the tie bar 70, the tie bar nut 81 on the side in the longitudinal direction Y where the fixed die 21 is located. That is, the control device 100 drives the mold thickness adjustment motor 84 to rotate the annular gear 86 by means of the driving gear 85 and rotates the tie bar nut gear 87 by means of the annular gear 86, and thereby positively rotates the tie bar nut 81. Thereby, the link housing 30 is moved together with the tie bar nuts 81 toward where the fixed die 21 is located, and the movable die 22 coupled to the link housing 30 via the toggle links 41 is moved toward where the fixed die 21 is located. Thus, the movable die 22 can be brought close to the fixed die 21 by an amount equivalent to the decrease in the thickness of the molds 25, and an appropriate mold clamping force can be generated in the mold clamping step.

Conversely, in the case where the thickness in the longitudinal direction Y of the molds 25 after replacement is larger than the thickness of the molds 25 before replacement, the control device 100 drives the mold thickness adjustment motor 84 included in the mold thickness adjustment mechanism 80 to reversely rotate the tie bar nut 81, and thereby moves, with respect to the tie bar 70, the tie bar nut 81 in the longitudinal direction Y opposite to where the fixed die 21 is located. Thereby, the link housing 30 is moved together with the tie bar nuts 81 opposite to where the fixed die 21 is located, and the movable die 22 coupled to the link housing 30 via the toggle links 41 is moved opposite to where the fixed die 21 is located. Thus, the movable die 22 can be moved away from the fixed die 21 by an amount equivalent to the increase in the thickness of the molds 25, and an appropriate mold clamping force can be generated in the mold clamping step.

Next, a mold clamping method used when performing the mold clamping of the molds 25 by means of the injection molding machine 1 according to the present embodiment is described. For the mold clamping force generated in the mold clamping step for the molds 25, mold clamping force is generated by a process in which the tie bar 70 elongates in the longitudinal direction Y and a reaction force with a tendency for the elongated tie bar 70 to contract is transmitted to the molds 25. Thus, the elongation of the tie bar 70 in the mold clamping step moves the movable die 22 forward by means of the toggle link 41 of the mold opening/closing mechanism 40, extends the toggle link 41 even after the fixed mold 26 and the movable mold 27 come into contact with each other, thus widens the distance between the link housing 30 and the movable die 22, and thereby moves the link housing 30 backward in the longitudinal direction Y.

Thereby, also the tie bar nut 81 placed on the link housing 30 is moved backward together with the link housing 30, and the tie bar 70 to which the tie bar nut 81 is screwed is elongated in the backward direction in the longitudinal direction Y. A reaction force with a tendency for the thus elongated tie bar 70 to contract is transmitted to the fixed die 21 and the movable die 22, and is transmitted to the molds 25; thereby, mold clamping force is generated.

When Generating Mold Clamping Force on the Molds 25 by elongating the tie bar 70, the tie bar 70 is elongated by the tie bar nut 81 screwed onto the tie bar 70; however, a gap is interposed between the screw portion 81a of the tie bar nut 81 and the screw portion 71 of the tie bar 70. That is, there is a backlash between the screw portion 81a of the tie bar nut 81 and the screw portion 71 of the tie bar 70, and therefore there is a gap between both screw portions. Thus, when the tie bar nut 81 and the tie bar 70 are free from forces acting on each other, the tie bar nut 81 is lowered on the lower side due to its own weight.

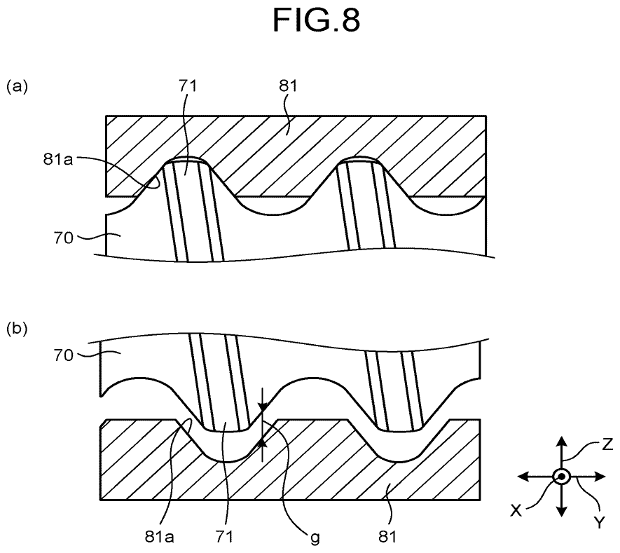

FIG. 7 is a detailed diagram of the tie bar 70 and the tie bar nut 81. FIG. 8 is a detailed diagram of a Ba portion and a Bb portion of FIG. 7. In FIG. 8, (a) is a detailed diagram of the Ba portion of FIG. 7, and (b) is a detailed diagram of the Bb portion of FIG. 7. When the tie bar nut 81 and the tie bar 70 are free from forces acting on each other, the tie bar nut 81 is lowered on the lower side due to its own weight; therefore, in a portion located on the upper side of the screw portion 81a of the tie bar nut 81 and the screw portion 71 of the tie bar 70, as illustrated in (a) of FIG. 8, the screw portion 81a of the tie bar nut 81 is in contact with the screw portion 71 of the tie bar 70. In contrast, in a portion located on the lower side of the screw portion 81a of the tie bar nut 81 and the screw portion 71 of the tie bar 70, as illustrated in (b) of FIG. 8, the screw portion 81a of the tie bar nut 81 has a gap g in the up-down direction Z with respect to the screw portion 71 of the tie bar 70.

In this state, when the movable die 22 is moved forward by the toggle links 41 of the mold opening/closing mechanism 40 to bring the fixed mold 26 and the movable mold 27 into contact with each other and the toggle links 41 are further extended to generate mold clamping force on the molds 25, a reaction force due to the mold clamping force is transmitted to the link housing 30 via the toggle links 41. That is, due to the mold clamping force, a force in the longitudinal direction Y opposite to where the fixed die 21 is located acts on the link housing 30, and from the link housing 30, this force acts also on the tie bar nut 81 placed on the link housing 30.

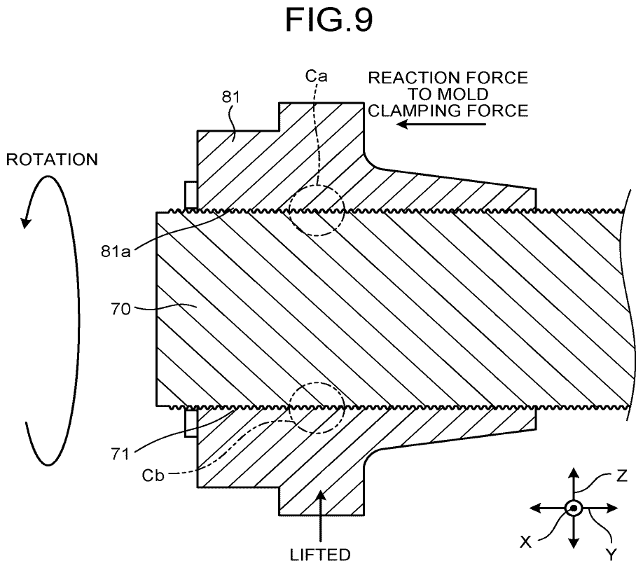

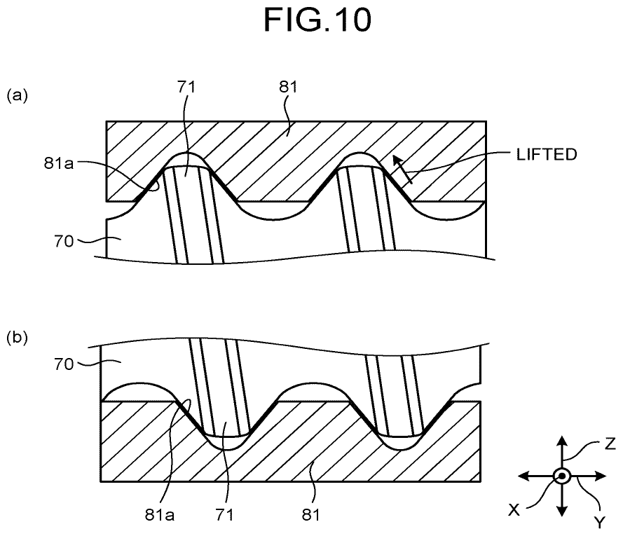

FIG. 9 is a detailed diagram of the tie bar 70 and the tie bar nut 81 when a reaction force to mold clamping force acts on the tie bar nut 81 in a conventional injection molding machine 1. FIG. 10 is a detailed diagram of a Ca portion and a Cb portion of FIG. 9. In FIG. 10, (a) is a detailed diagram of the Ca portion of FIG. 9, and (b) is a detailed diagram of the Cb portion of FIG. 9. In the conventional injection molding machine 1, when mold clamping force is generated on the molds 25 in the mold clamping step, a reaction force to the mold clamping force acts on the tie bar nut 81 from the link housing 30, and a large force in the opposite direction in the longitudinal direction Y to the direction toward where the fixed die 21 is located acts on the tie bar nut 81. That is, in the mold clamping step, a large force in the backward direction in the longitudinal direction Y acts on the tie bar nut 81 due to a reaction force to the mold clamping force.

When a force in the backward direction in the longitudinal direction Y acts on the tie bar nut 81, in a portion located on the upper side of the screw portion 81a of the tie bar nut 81 and the screw portion 71 of the tie bar 70, as illustrated in (a) of FIG. 10, the screw portion 81a of the tie bar nut 81 moves along the screw crest of the screw portion 71 of the tie bar 70, and thereby the tie bar nut 81 is lifted on the upper side.

Thus, also in a portion located on the lower side of the screw portion 81a of the tie bar nut 81 and the screw portion 71 of the tie bar 70, as illustrated in (b) of FIG. 10, the gap between the screw portion 81a of the tie bar nut 81 and the screw portion 71 of the tie bar 70 disappears, and the screw portion 81a of the tie bar nut 81 and the screw portion 71 of the tie bar 70 come into contact with each other over the entire circumference.

However, during the time when the force in the backward direction due to the reaction force to the mold clamping force lifts the tie bar nut 81 on the upper side, until the lifting is completed, the screw portion 81a of the tie bar nut 81 and the screw portion 71 of the tie bar 70 do not yet reach a state of being in contact with each other over the entire circumference. That is, during the time until the force in the backward direction due to the reaction force to the mold clamping force completely lifts the tie bar nut 81 on the upper side, the screw portion 81a of the tie bar nut 81 and the screw portion 71 of the tie bar 70 are in an incomplete contact state. During this time, when the force of reverse rotation that is generated by the force in the backward direction and that has a tendency to reversely rotate the tie bar nut 81 becomes larger than the frictional resistance at the contact portion between the screw portion 81a of the tie bar nut 81 and the screw portion 71 of the tie bar 70, the screw portion 81a of the tie bar nut 81 moves in the direction of reverse rotation along the spiral of the screw portion 71 of the tie bar 70, and the tie bar nut 81 moves backward along the tie bar 70.

Also during the time when the tie bar nut 81 moves backward along the tie bar 70 while rotating reversely, the force in the backward direction due to the reaction force to the mold clamping force lifts the tie bar nut 81 on the upper side. Thus, when the tie bar nut 81 is completely lifted on the upper side by the reaction force to the mold clamping force, and the screw portion 81a of the tie bar nut 81 and the screw portion 71 of the tie bar 70 reach a state of being in contact with each other over the entire circumference, the backward movement due to reverse rotation of the tie bar nut 81 stops.

The tie bar nut 81 is a member that adjusts the positions in the longitudinal direction Y of the link housing 30 and the movable die 22 so that an appropriate magnitude of mold clamping force can be generated on the molds 25; however, when the tie bar nut 81 moves in the longitudinal direction Y, also the link housing 30 and the movable die 22 move together with the tie bar nut 81. In this case, in the mold clamping step when performing injection molding with the injection molding machine 1, it may be difficult to generate an appropriate magnitude of mold clamping force on the molds 25.

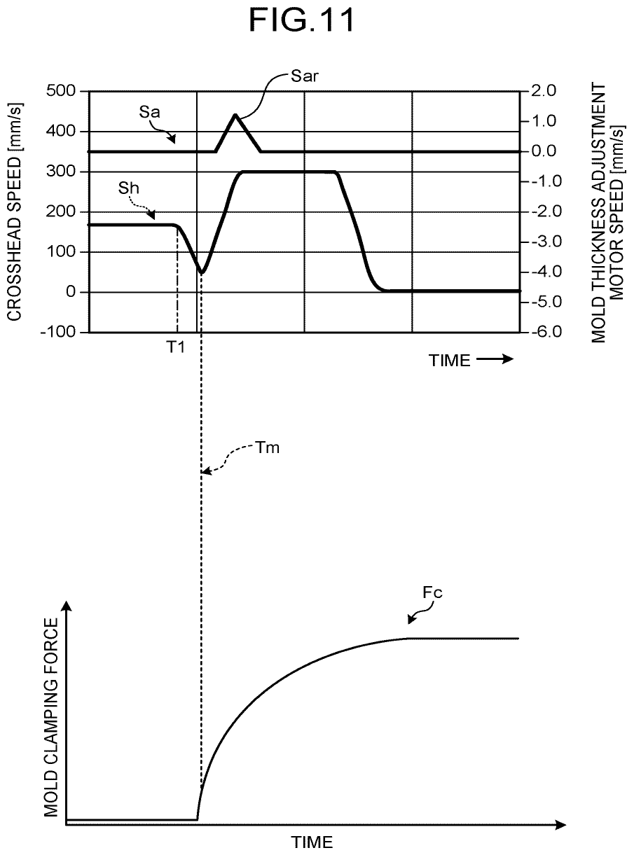

FIG. 11 is an explanatory diagram illustrating relationships between an operation of the crosshead 52 and changes in mold clamping force Fc, and movement of the mold thickness adjustment motor 84 when performing mold clamping by means of the conventional injection molding machine 1. When performing the mold clamping of the molds 25 by means of the injection molding machine 1, the crosshead 52 is moved forward by the driving force generated by the mold clamping motor 60 of the mold opening/closing mechanism 40 and thereby the toggle links 41 are driven, and the movable die 22 is moved forward in the longitudinal direction Y. Thus, when performing the mold clamping of the molds 25, as illustrated in FIG. 11, the crosshead 52 moves in the longitudinal direction Y at a predetermined crosshead speed Sh.

When performing the mold clamping of the molds 25, in the movement of the crosshead 52, upon reaching a deceleration timing T1 that is set based on a mold clamping timing Tm that is a timing at which the fixed mold 26 and the movable mold 27 come into contact with each other and mold clamping force Fc is generated, the control device 100 reduces the crosshead speed Sh. The mold clamping timing Tm and the deceleration timing T1 may be time settings, position settings, or distance settings with respect to the movement of the crosshead 52. The deceleration timing T1 is set to a timing before the mold clamping timing Tm. In other words, the deceleration timing T1 is set to a timing earlier than the mold clamping timing Tm. The mold clamping timing Tm is a timing at which, when controlling the mold closing and mold clamping of the molds 25, the fixed mold 26 and the movable mold 27 separated from each other come into contact with each other. The mold clamping timing Tm and the deceleration timing T1 are adjusted at the same time as mold thickness adjustment by the mold thickness adjustment mechanism 80.

In the conventional injection molding machine 1, the crosshead speed Sh is reduced, and upon reaching the mold clamping timing Tm, the control device 100 increases the crosshead speed Sh as illustrated in FIG. 11. At this time, the control device 100 adjusts the crosshead speed Sh while moving the crosshead 52 forward without stopping the crosshead 52. That is, the control device 100 adjusts the crosshead speed Sh without setting the crosshead speed Sh to 0. Thus, by increasing the crosshead speed Sh with the control device 100, the tie bar 70 elongates and a reaction force against the elongation of the tie bar 70 acts on the molds 25, and therefore the mold clamping force Fc increases. When the mold clamping force Fc is increased to some degree, the control device 100 reduces the crosshead speed Sh, and keeps the mold clamping force Fc.

Here, when the crosshead speed Sh is rapidly increased while the crosshead 52 is moved forward, the tie bar nut 81 is likely to rotate reversely. That is, when the crosshead speed Sh is rapidly increased while the crosshead 52 is moved forward, the tie bar 70 elongates rapidly, and a reaction force to the mold clamping force Fc generated on the molds 25 rapidly acts on the tie bar nut 81 from the link housing 30.

Thereby, a force in the backward direction in the longitudinal direction Y acts on the tie bar nut 81 in a state of being lowered downward due to its own weight; thus, as illustrated in FIG. 10, a portion located on the upper side of the screw portion 81a comes into contact with the screw portion 71 of the tie bar 70, and the tie bar nut 81 tends to be lifted along the screw crest of the screw portion 71 of the tie bar 70. Then, during the time when a force in the backward direction due to the reaction force to the mold clamping force rapidly acts on the tie bar nut 81, a force of reverse rotation that is generated by the force in the backward direction and that has a tendency to reversely rotate the tie bar nut 81 increases. Thus, the force of reverse rotation of the tie bar nut 81 becomes larger than the frictional resistance at the contact portion between the screw portion 81a of the tie bar nut 81 and the screw portion 71 of the tie bar 70, the screw portion 81a of the tie bar nut 81 moves in the direction of reverse rotation along the spiral of the screw portion 71 of the tie bar 70, and the tie bar nut 81 moves backward along the tie bar 70.

However, also during the time when the tie bar nut 81 moves backward along the tie bar 70, the force in the backward direction due to the reaction force to the mold clamping force lifts the tie bar nut 81 on the upper side; thus, when the tie bar nut 81 is lifted and the screw portion 81a of the tie bar nut 81 and the screw portion 71 of the tie bar 70 reach a state of being in contact with each other over the entire circumference, the backward movement due to reverse rotation of the tie bar nut 81 stops. After the backward movement due to reverse rotation of the tie bar nut 81 is stopped, by the movement of the crosshead 52, the mold clamping force Fc increases without a decrease due to reverse rotation of the tie bar nut 81.

In the conventional injection molding machine 1, as illustrated in FIG. 11, the reverse rotation of the tie bar nut 81 when generating mold clamping force appears also in a mold thickness adjustment motor speed Sa that is the rotation speed of the mold thickness adjustment motor 84. That is, when the tie bar nut 81 rotates reversely, the reverse rotation of the tie bar nut 81 is transmitted from the tie bar nut gear 87 to the annular gear 86, is transmitted from the annular gear 86 to the driving gear 85, and is thereby transmitted to the mold thickness adjustment motor 84.

Thereby, during injection molding of the injection molding machine 1, the mold thickness adjustment motor 84 rotates reversely as indicated by the fact that the mold thickness adjustment motor speed Sa, which is originally supposed to be 0, changes to Sar due to the reverse rotation of the tie bar nut 81 occurring when mold clamping force is generated on the molds 25. That is, the reverse rotation of the tie bar nut 81 when mold clamping force is generated on the molds 25 appears also in the mold thickness adjustment motor speed Sa.

If the tie bar nut 81 unnecessarily rotates backward during injection molding of the injection molding machine 1, the distance in the longitudinal direction Y between the fixed mold 26 and the link housing 30 changes, accordingly the distance in the longitudinal direction Y between the fixed mold 26 and the movable mold 27 changes, and thus it may be difficult to generate an appropriate magnitude of mold clamping force on the molds 25.

In contrast, in the injection molding machine 1 according to the present embodiment, when performing the mold clamping of the molds 25, the mold clamping force Fc is increased after a preload is applied to the molds 25, and thereby unnecessary reverse rotation of the tie bar nut 81 is suppressed.

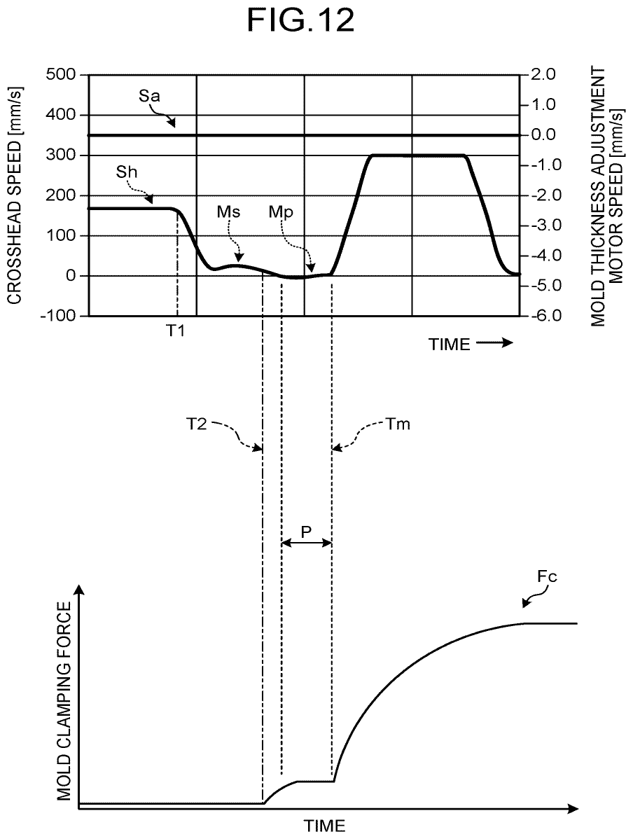

FIG. 12 is an explanatory diagram illustrating relationships between an operation of the crosshead 52 and changes in mold clamping force Fc, and movement of the mold thickness adjustment motor 84 when performing mold clamping by means of the injection molding machine 1 according to the embodiment. In the injection molding machine 1 according to the present embodiment, when performing mold clamping by, from a state where the molds 25 are opened, closing the molds 25 by means of the mold opening/closing mechanism 40, first, upon reaching a deceleration timing T1 set in advance based on a mold clamping timing Tm, the control device 100 decelerates the mold clamping motor 60 to reduce the crosshead speed Sh.

Next, immediately before the movable mold 27 and the fixed mold 26 come into contact with each other, the control device 100 sets the rotation of the mold clamping motor 60 to slow-speed rotation. That is, at the deceleration timing T1, the control device 100 decelerates the mold clamping motor 60 to reduce the crosshead speed Sh; then, the control device 100 rotates the mold clamping motor 60 in a slow-speed rotation mode Ms. Thereby, the movable mold 27 attached to the movable die 22 is brought close to the fixed mold 26 at slow speed. The movement speed of the movable mold 27 when bringing it close to the fixed mold 26 at slow speed is, for example, preferably in the range of 2.0 mm/s or more and 7.0 mm/s or less.

When the movable mold 27 and the fixed mold 26 come into contact with each other by bringing the movable mold 27 close to the fixed mold 26 at slow speed, the control device 100 stops the mold clamping motor 60 for a predetermined period. The contact between the movable mold 27 and the fixed mold 26 is detected by the control device 100 on the basis of a detection result of the tie bar sensor 75 attached to the tie bar 70. That is, when the movable mold 27 comes into contact with the fixed mold 26 while moving at slow speed and the parting surface between the movable mold 27 and the fixed mold 26 is closed, and thus the mold closing of the molds 25 is performed, the tie bar 70 elongates extremely slightly.

The tie bar sensor 75 detects this extremely slight elongation of the tie bar 70, and outputs the detection result to the control device 100 as a low-pressure mold clamping force detection signal. The control device 100 that has acquired the low-pressure mold clamping force detection signal from the tie bar sensor 75 performs control toward a preload mode Mp that is a mode in which the mold clamping motor 60 is stopped for a predetermined period P.

Specifically, in a state where the mold clamping motor 60 is rotated in the slow-speed rotation mode Ms and the movable mold 27 is being brought close to the fixed mold 26 at slow speed, when a low-pressure mold clamping force detection signal from the tie bar sensor 75 is acquired by the control device 100, the control device 100 further decelerates the rotation of the mold clamping motor 60 from the timing T2 of acquisition of the low-pressure mold clamping force detection signal. Thereby, also the crosshead speed Sh decreases after the timing T2 of acquisition of the low-pressure mold clamping force detection signal.

Here, since the timing T2 of acquisition of the low-pressure mold clamping force detection signal is a timing at which the fixed mold 26 and the movable mold 27 come into contact with each other, after the timing T2 of acquisition of the low-pressure mold clamping force detection signal, even when the rotation of the mold clamping motor 60 is decelerated, also the crosshead 52 continues to move at slow speed until the rotation of the mold clamping motor 60 stops. Thereby, the mold clamping force Fc of the molds 25 slightly increases with the movement of the crosshead 52.

When the rotation of the mold clamping motor 60 is decelerated and the rotation speed of the mold clamping motor 60 becomes 0, the control device 100 transitions to the preload mode Mp, and stops the mold clamping motor 60 for a predetermined period P. In other words, after an arbitrary deceleration period that is a period until the mold clamping motor 60 is stopped elapses after the timing T2 of acquisition of the low-pressure mold clamping force detection signal, the control device 100 sets the rotation speed of the mold clamping motor 60 to 0, and stops the mold clamping motor 60 for a predetermined period P.

In the preload mode Mp, the control device 100 applies, to the molds 25, a preload that is a mold clamping force Fc significantly smaller than the maximum mold clamping force Fc at the time of injection molding. In the predetermined period P in which the mold clamping motor 60 is stopped, the control device 100 applies, to the molds 25 as a preload, a mold clamping force Fc in the range of 2.0% or more and 5.0% or less of the maximum mold clamping force applied to the molds 25 by the mold opening/closing mechanism 40.

Thus, the preload applied to the molds 25 in the preload mode Mp is a mold clamping force Fc of the molds 25 that includes a slight increase caused while the mold clamping motor 60 is gradually decelerated during the time until the rotation of the mold clamping motor 60 is stopped after the timing T2 of acquisition of the low-pressure mold clamping force detection signal. Therefore, the magnitude of the preload can be adjusted by adjusting the time required to stop the rotation of the mold clamping motor 60 after the timing T2 of acquisition of the low-pressure mold clamping force detection signal.

In the present embodiment, the predetermined period P in which the mold clamping motor 60 is stopped in the preload mode Mp is about 0.3 seconds. That is, in the preload mode Mp, the control device 100 applies a preload to the molds 25 for about 0.3 seconds. The predetermined period P in which the mold clamping motor 60 is thus stopped in the preload mode Mp is preferably in the range of 0.3 seconds or more and 1.0 seconds or less.

When the predetermined period P has elapsed in a state where a preload is applied to the molds 25, the control device 100 increases the rotation speed of the mold clamping motor 60 after the predetermined period P elapses, and thus performs the mold clamping of the molds 25. That is, in the present embodiment, the timing at which the predetermined period P has elapsed in the preload mode Mp is the mold clamping timing Tm, and when the predetermined period P has elapsed in a state where a preload is applied to the molds 25, the control device 100 increases the rotation speed of the mold clamping motor 60 to increase the crosshead speed Sh. Thereby, the tie bar 70 elongates, and a reaction force against the elongation of the tie bar 70 acts on the molds 25; thus, the mold clamping force Fc increases. When the mold clamping force Fc is increased to some degree, the control device 100 reduces the crosshead speed Sh, and keeps the mold clamping force Fc.

In the present embodiment, a preload is applied to the molds 25 before the mold clamping force Fc is increased at the mold clamping timing Tm. Although the preload on the molds 25 is a mold clamping force Fc significantly smaller than the maximum mold clamping force Fc, during application of the preload, a reaction force to the mold clamping force Fc corresponding to the preload acts on the tie bar nut 81 from the link housing 30.

Thereby, a force in the backward direction in the longitudinal direction Y acts on the tie bar nut 81 in a state of being lowered downward due to its own weight; thus, as illustrated in FIG. 10, a portion located on the upper side of the screw portion 81a comes into contact with the screw portion 71 of the tie bar 70, and the tie bar nut 81 is lifted along the screw crest of the screw portion 71 of the tie bar 70. Also in a portion located on the lower side of the screw portion 81a of the tie bar nut 81 and the screw portion 71 of the tie bar 70, the screw portion 81a of the tie bar nut 81 and the screw portion 71 of the tie bar 70 come into contact with each other, and thereby the screw portion 81a and the screw portion 71 come into contact with each other over the entire circumference. Thus, a frictional force is secured between the screw portion 81a of the tie bar nut 81 and the screw portion 71 of the tie bar 70.

On the other hand, since the reaction force to the mold clamping force Fc corresponding to the preload is significantly weaker than the maximum mold clamping force Fc, no enough force to reversely rotate the tie bar nut 81 acts on the tie bar nut 81 from the link housing 30. Therefore, the tie bar nut 81 is lifted along the screw portion 71 of the tie bar 70, and moves to such an extent that the screw portion 81a of the tie bar nut 81 and the screw portion 71 of the tie bar 70 come into contact with each other over the entire circumference.

In the present embodiment, after the screw portion 81a of the tie bar nut 81 and the screw portion 71 of the tie bar 70 thus come into contact with each other over the entire circumference and a frictional force is secured between them, the mold clamping force Fc is increased at the mold clamping timing Tm. Thus, although also the reaction force to the mold clamping force acting on the tie bar nut 81 from the link housing 30 increases, at the timing at which the reaction force to the mold clamping force increases, a frictional force between the screw portion 81a of the tie bar nut 81 and the screw portion 71 of the tie bar 70 is already secured.

Thereby, even when also the reaction force to the mold clamping force acting on the tie bar nut 81 from the link housing 30 increases, the tie bar nut 81 is prevented from rotating reversely by the frictional force between the screw portion 81a of the tie bar nut 81 and the screw portion 71 of the tie bar 70, and the tie bar nut 81 is kept stopped in the rotation direction. Therefore, as illustrated in FIG. 12, also the mold thickness adjustment motor speed Sa is kept at 0.

In the present embodiment, when performing the mold clamping of the molds 25, since the tie bar nut 81 is thus not reversely rotated by the reaction force to the mold clamping force, even when injection molding of the injection molding machine 1 is repeated, the distance in the longitudinal direction Y between the fixed mold 26 and the link housing 30 does not change, and the distance in the longitudinal direction Y between the fixed mold 26 and the movable mold 27 does not change; therefore, an appropriate magnitude of mold clamping force can be continuously generated on the molds 25.

### <Effects of the Embodiment>

The mold clamping device 20 and the mold clamping method for the mold clamping device 20 according to the above embodiment, when performing mold clamping by closing the molds 25 by means of the mold opening/closing mechanism 40, set the rotation of the mold clamping motor 60 to slow-speed rotation immediately before the movable mold 27 and the fixed mold 26 come into contact with each other, thereby bring the movable mold 27 close to the fixed mold 26 at slow speed, and stop the mold clamping motor 60 for a predetermined period P if the movable mold 27 and the fixed mold 26 come into contact with each other. Thereby, before a reaction force to large mold clamping force acts on the tie bar nut 81 from the link housing 30, the screw portion 81a of the tie bar nut 81 and the screw portion 71 of the tie bar 70 can be brought into contact with each other over the entire circumference, and a frictional force between them can be secured. The control device 100 thus secures a frictional force between the screw portion 81a of the tie bar nut 81 and the screw portion 71 of the tie bar 70, increases the rotation speed of the mold clamping motor 60 after a predetermined period P elapses, and thus performs the mold clamping of the molds 25.

Thereby, even when a reaction force to large mold clamping force acts on the tie bar nut 81 from the link housing 30, reverse rotation of the tie bar nut 81 can be suppressed by the frictional force between the screw portion 81a of the tie bar nut 81 and the screw portion 71 of the tie bar 70. Therefore, even when the mold clamping of the molds 25 is repeatedly performed, the distance in the longitudinal direction Y between the fixed mold 26 and the link housing 30 does not change, thus a change in the magnitude of mold clamping force generated on the molds 25 can be suppressed, and an appropriate magnitude of mold clamping force can be continuously generated on the molds 25. As a result, a decrease in mold clamping force can be suppressed.

Further, in a predetermined period P in which the mold clamping motor 60 is stopped, the control device 100 applies, to the molds 25, a mold clamping force in the range of 2.0% or more and 5.0% or less of the maximum mold clamping force applied to the molds 25 by the mold opening/closing mechanism 40; thus, a frictional force between the screw portion 81a of the tie bar nut 81 and the screw portion 71 of the tie bar 70 can be secured while reverse rotation of the tie bar nut 81 due to a reaction force to mold clamping force is suppressed. Therefore, when the mold clamping of the molds 25 is repeatedly performed, a change in the magnitude of mold clamping force generated on the molds 25 can be more reliably suppressed. As a result, a decrease in mold clamping force can be Suppressed.

Further, since the predetermined period P in which the mold clamping motor 60 in stopped is in the range of 0.3 seconds or more and 1.0 seconds or less, the screw portion 81a of the tie bar nut 81 and the screw portion 71 of the tie bar 70 can be more reliably brought into contact with each other over the entire circumference and a frictional force between them can be secured while the time of the mold clamping step becoming too long is suppressed. Therefore, when the mold clamping of the molds 25 is repeatedly performed, a change in the magnitude of mold clamping force generated on the molds 25 can be more reliably suppressed. As a result, a decrease in mold clamping force can be suppressed.

The injection molding machine 1 according to the embodiment includes the injection device 10 and the mold clamping device 20 described above, and therefore can suppress reverse rotation of the tie bar nut 81 included in the mold clamping device 20 during injection molding by the injection molding machine 1. Thereby, even when injection molding is repeatedly performed by the injection molding machine 1, a change in the magnitude of mold clamping force generated on the molds 25 can be suppressed, and an appropriate magnitude of mold clamping force can be continuously generated on the molds 25. As a result, a decrease in mold clamping force can be suppressed.

### [Modification Examples]

Although in the embodiment described above the mold opening/closing mechanism 40 transmits the driving force generated by the mold clamping motor 60 to the ball screw 51 by means of the first pulley 61, the second pulley 62, and the timing belt 63, the configuration for transmitting the driving force generated by the mold clamping motor 60 to the ball screw 51 may be other configurations. Similarly, although the mold thickness adjustment mechanism transmits the driving force generated by the mold thickness adjustment motor 84 to the tie bar nut 81 by means of the driving gear 85, the annular gear 86, and the tie bar nut gear 87, the configuration for transmitting the driving force generated by the mold thickness adjustment motor 84 to the tie bar nut 81 may be other configurations.

Further, although in the embodiment described above the mold clamping force generated on the molds 25 is detected by the tie bar sensor 75 placed on the tie bar 70, the mold clamping force may be detected by means other than the tie bar sensor 75.

### EXPLANATIONS OF LETTERS OR NUMERALS

1 INJECTION MOLDING MACHINE
5 FRAME
6 COVER
10 INJECTION DEVICE
11 INJECTION CYLINDER
12 NOZZLE
13 SCREW
14 HOPPER
20 MOLD CLAMPING DEVICE
21 FIXED DIE
22 MOVABLE DIE
25 MOLD
26 FIXED MOLD
27 MOVABLE MOLD
30 LINK HOUSING
31 THROUGH HOLE
40 MOLD OPENING/CLOSING MECHANISM
41 TOGGLE LINK
42 CROSSHEAD-SIDE LINK
43 LINK HOUSING-SIDE LINK
44 MOVABLE DIE-SIDE LINK
45 TOGGLE LINK COUPLING UNIT
50 DRIVING DEVICE
51 BALL SCREW
52 CROSSHEAD
53 NUT
60 MOLD CLAMPING MOTOR
61 FIRST PULLEY
62 SECOND PULLEY
63 TIMING BELT
70 TIE BAR
71 SCREW PORTION
75 TIE BAR SENSOR
80 MOLD THICKNESS ADJUSTMENT MECHANISM
81 TIE BAR NUT
81a SCREW PORTION
81b FLANGE PORTION
82 NUT SUPPORT MEMBER
83 THRUST WASHER
84 MOLD THICKNESS ADJUSTMENT MOTOR
85 DRIVING GEAR
86 ANNULAR GEAR
87 TIE BAR NUT GEAR
90 FIRST LINEAR GUIDE
91 FIRST GUIDE RAIL
92 FIRST BLOCK
95 SECOND LINEAR GUIDE
96 SECOND GUIDE RAIL
97 SECOND BLOCK
100 CONTROL DEVICE
101 DISPLAY UNIT
102 INPUT UNIT

1. A mold clamping device comprising:
a fixed die to which a fixed mold of a pair of molds composed of the fixed mold and a movable mold, is attached;
a movable die to which the movable mold is attached and that is placed with such an orientation that the movable mold faces the fixed mold attached to the fixed die;
a link housing placed opposite to where the fixed die is placed with respect to the movable die;
a mold opening/closing mechanism that includes a toggle link and a mold clamping motor driving the toggle link, the toggle link being coupled to the link housing and the movable die and being capable of changing a distance between the link housing and the movable die, the mold opening/closing mechanism driving the toggle link by driving force generated by the mold clamping motor, to move the movable die with respect to the link housing, and thereby perform opening/closing and mold clamping of the movable mold attached to the movable die and the fixed mold;
a tie bar having one end fixed to the fixed die and a second end coupled to the link housing;
a mold thickness adjustment mechanism that includes a tie bar nut screwed onto a screw portion formed on the second end of the tie bar and placed on the link housing, the mold thickness adjustment mechanism rotating the tie bar nut to move, relative to the tie bar, the link housing together with the tie bar nut in an extending direction of the tie bar and thereby adjusting relative positions of the movable mold and the fixed mold, the movable mold being attached to the movable die coupled to the link housing via the toggle link; and
a control device that controls the mold opening/closing mechanism and the mold thickness adjustment mechanism,
wherein when performing the mold clamping by, from a state where the molds are opened, closing the molds by the mold opening/closing mechanism, the control device sets rotation of the mold clamping motor to slow-speed rotation immediately before the movable mold and the fixed mold come into contact with each other, thereby brings the movable mold close to the fixed mold at a slow speed, stops the mold clamping motor for a predetermined period when the movable mold and the fixed mold come into contact with each other, and increases a rotation speed of the mold clamping motor after the predetermined period elapses, to perform the mold clamping.

2. The mold clamping device according to claim 1, wherein during the predetermined period in which the mold clamping motor is stopped, the control device applies, to the molds, the mold clamping force in a range of 2.0% or more and 5.0% or less of a maximum mold clamping force applied to the molds by the mold opening/closing mechanism.

3. The mold clamping device according to claim 1, wherein the predetermined period in which the mold clamping motor is stopped is in a range of 0.3 seconds or more and 1.0 seconds or less.

4. An injection molding machine comprising:
the mold clamping device according to claim 1; and
an injection device that melts a resin material in an injection cylinder having a screw placed inside and injects the molten resin material from a nozzle to the molds.

5. A mold clamping method for a mold clamping device, the mold clamping device including:
a fixed die to which a fixed mold of a pair of molds composed of the fixed mold and a movable mold, is attached;
a movable die to which the movable mold is attached and that is placed with such an orientation that the movable mold faces the fixed mold attached to the fixed die;
a link housing placed opposite to where the fixed die is placed with respect to the movable die;
a mold opening/closing mechanism that includes a toggle link and a mold clamping motor driving the toggle link, the toggle link being coupled to the link housing and the movable die and being capable of changing a distance between the link housing and the movable die, the mold opening/closing mechanism driving the toggle link by driving force generated by the mold clamping motor, to move the movable die with respect to the link housing, and thereby perform opening/closing and mold clamping of the movable mold attached to the movable die and the fixed mold;
a tie bar having one end fixed to the fixed die and a second end coupled to the link housing; and
a mold thickness adjustment mechanism that includes a tie bar nut screwed onto a screw portion formed on the second end of the tie bar and placed on the link housing, the mold thickness adjustment mechanism rotating the tie bar nut to move, relative to the tie bar, the link housing together with the tie bar nut in an extending direction of the tie bar and thereby adjusting relative positions of the movable mold and the fixed mold, the movable mold being attached to the movable die coupled to the link housing via the toggle link,
the mold clamping method comprising
when performing the mold clamping by, from a state where the molds are opened, closing the molds by the mold opening/closing mechanism, setting rotation of the mold clamping motor to slow-speed rotation immediately before the movable mold and the fixed mold come into contact with each other, thereby bringing the movable mold close to the fixed mold at a slow speed, stopping the mold clamping motor for a predetermined period when the movable mold and the fixed mold come into contact with each other, and increasing a rotation speed of the mold clamping motor after the predetermined period elapses, to perform the mold clamping.

6. An injection molding machine comprising:
the mold clamping device according to claim 2; and
an injection device that melts a resin material in an injection cylinder having a screw placed inside and injects the molten resin material from a nozzle to the molds.

7. An injection molding machine comprising:
the mold clamping device according to claim 3; and
an injection device that melts a resin material in an injection cylinder having a screw placed inside and injects the molten resin material from a nozzle to the molds.
